(19) United States
(12) Patent Application Publication
(10) Pub. No.: US 2024/0082990 A1
(43) Pub. Date: Mar. 14, 2024

(54) Reversible Ratchet Mechansim

(71) Applicant: Milwaukee Electric Tool Corporation, Brookfield, WI (US)

(72) Inventors: Jack C. Melkovitz, Wauwatosa, WI (US); Stephan N. Popescu, Scarsdale, NY (US)

(21) Appl. No.: 18/361,269

(22) Filed: Jul. 28, 2023

Related U.S. Application Data
(60) Provisional application No. 63/375,146, filed on Sep. 9, 2022.

(51) Int. Cl. B25B 13/46

(52) U.S. Cl. CPC B25B 13/463

(57) ABSTRACT

A tool with a reversible ratchet mechanism is shown. The ratchet mechanism includes a gear structure, pawl structure, and a switching mechanism such that the ratchet mechanism allows tightening in the clockwise and counterclockwise direction. The ratchet mechanism further includes a biasing component for pawl movement and another biasing component engaged with the switching mechanism to provide tactile feedback.

### CROSS-REFERENCE TO RELATED PATENT APPLICATION

The present application claims the benefit of and priority to U.S. Provisional Application No. 63/375,146 filed on Sep. 9, 2022, which is incorporated herein by reference in its entirety.

### BACKGROUND OF THE INVENTION

The present invention relates generally to the field of tools. The present invention relates specifically to a tool with a reversible ratchet mechanism, such as a ratchet wrench, a combo wrench with ratchet mechanism, socket wrench with ratchet mechanism, screw driver with ratchet mechanism, etc. Ratchet mechanisms are used in a variety of tools that use a twisting or rotating motion of the tool, typically to drive a fastener component (e.g., a nut, a bolt, a screw, etc.), and the ratchet mechanism allows the tool or tool handle to be rotated relative to the fastening component to reset the handle position without driving the fastening component and without requiring the tool to be disengaged from the fastening component.

### SUMMARY OF THE INVENTION

One embodiment of the invention relates to a ratcheting wrench. The ratcheting wrench includes a head, a body, a workpiece engagement structure, and a ratchet mechanism. The body extends along a longitudinal axis and the head is coupled to the body. The workpiece engagement structure is coupled to the head. The ratchet mechanism is supported by the head. The ratchet mechanism includes a gear coupled to the workpiece engagement structure and the gear includes a plurality of gear teeth. The ratchet mechanism further includes a first pawl, a second pawl and a first biasing component. The first pawl includes a plurality of pawl teeth configured to engage the gear teeth of the gear. The second pawl includes a plurality of pawl teeth configured to engage the gear teeth of the gear. The first biasing component extends between and engages the first pawl and the second pawl. The ratcheting wrench further includes a switching assembly positioned within the body. The switching assembly includes an elongate switch, a second biasing component, and a ball positioned between the elongate switch and the second biasing component and engaging the elongate switch and the second biasing component. The elongate switch is translationally movable between a first driving position in which the first pawl is engaged with the gear and the second pawl is disengaged from the gear and a second driving position in which the second pawl is engaged with the gear and the first pawl is disengaged from the gear by the elongate switch.

Another embodiment of the invention relates to a ratcheting tool. The ratcheting tool includes a head, a body, a workpiece engagement structure, and a ratchet mechanism. The body extends along a longitudinal axis and the head is coupled to the body. The workpiece engagement structure is coupled to the head. The ratchet mechanism is supported by the head and coupled to the workpiece engagement structure. The ratchet mechanism includes a gear that includes a plurality of gear teeth, a first pawl, and a second pawl. The first pawl includes a plurality of pawl teeth configured to engage the gear teeth of the gear, a first post having an outer surface, a first inward facing surface facing the first post, and a first channel. The first channel is defined between the first inward facing surface and the first post. The second pawl includes a plurality of pawl teeth configured to engage the gear teeth of the gear, a second post having an outer surface, a second inward facing surface facing the second post, and a second channel. The second channel is defined between the second inward facing surface and the second post. A pawl biasing component extends between and engages the first pawl and the second pawl. The ratcheting tool further includes a switching assembly positioned within the body. The switching assembly includes a switch, a switch biasing component and a ball. The switch includes a pair of arms extending toward the gear, the pair of arms are configured to engage with the first pawl and the second pawl to selectably move the first pawl and the second pawl into and out of engagement with the gear. The ball is positioned between the switch and the switch biasing component and engages the switch and the switch biasing component. The switch assembly is configured to move the ratchet mechanism between a first drive position and a second drive position.

Another embodiment of the invention relates to a reversible driving tool. The revesible driving tool includes a head, a body, a workpiece engagement structure, and a ratchet mechanism. The body extends along a longitudinal axis and the head is coupled to the body. The workpiece engagement structure is coupled to the head. The ratchet mechanism is supported by the head and coupled to the workpiece engagement structure. The ratchet mechanism includes a gear that includes a plurality of gear teeth, a first pawl, and a second pawl. The first pawl includes a plurality of pawl teeth configured to engage the gear teeth of the gear. The second pawl includes a plurality of pawl teeth configured to engage the gear teeth of the gear. A first biasing component extends between and engages the first pawl and the second pawl. The reversible driving tool further includes a switching assembly positioned within the body. The switching assembly includes a switch, a second biasing component and a ball. The switch is configured to engage with the first pawl and the second pawl to selectably move the first pawl and the second pawl into and out of engagement with the gear. The switch includes a downward facing surface including a first recess and a second recess. The ball is positioned between the switch and the second biasing component such that the ball engages the downward facing surface of the switch and the second biasing component. The switch is translationally movable within a passageway extending through the body in a direction transverse to the longitudinal axis. the switch is movable between a first driving position in which the first pawl is engaged with the gear and a second driving position in which the second pawl is engaged with the gear.

Additional features and advantages will be set forth in the detailed description which follows, and, in part, will be readily apparent to those skilled in the art from the description or recognized by practicing the embodiments as described in the written description and claims hereof, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments, and together with the description serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front perspective view of a tool, shown as a ratchet wrench, including a ratcheting mechanism, according to an exemplary embodiment.

FIG. 2 is a rear perspective view of the ratchet wrench of FIG. 1 with a linear switch of the ratchet mechanism in a first position, according to an exemplary embodiment.

FIG. 3 is a rear perspective view of the ratchet wrench of FIG. 1 with the linear switch of the ratchet mechanism in a second position, according to an exemplary embodiment.

FIG. 4 is a perspective view of the ratchet mechanism of the ratchet wrench of FIG. 1, according to an exemplary embodiment.

FIG. 5 is an exploded view of the ratchet mechanism of FIG. 4, according to an exemplary embodiment.

FIG. 6 is a detailed perspective view of a pawl of the ratchet mechanism of FIG. 4, according to an exemplary embodiment.

FIG. 7 is a cross-sectional view of the ratchet wrench taken along section line 7-7 of FIG. 2, showing the ratcheting mechanism mounted within a tool body, according to an exemplary embodiment.

FIG. 8 is a cross-sectional view of the ratchet wrench taken along section line 8-8 of FIG. 2, showing the ratcheting mechanism mounted within a tool body, according to an exemplary embodiment.

FIG. 9 is a partially exploded rear perspective view of the ratchet mechanism of FIG. 1 with a portion of the tool body removed when the linear switch is in the first position, according to an exemplary embodiment.

FIG. 10 is a rear perspective view of the ratchet mechanism of FIG. 1 when the linear switch is in the second position, according to an exemplary embodiment.

### DETAILED DESCRIPTION

Referring generally to the figures, various embodiments of a ratchet mechanism for a tool are shown and described. In general, ratchet mechanisms are used in a variety of tools that deliver torque to a workpiece such as a component of fastener (e.g., a nut, a bolt, a screw, etc.). The ratchet mechanism includes a switching mechanism such that the ratchet mechanism is reversible, allowing tightening in both the clockwise and counterclockwise direction. In contrast to the tool with a reversible ratchet mechanism discussed herein, tools with reversible rotary ratchet mechanisms typically have low reverse torque (i.e., the force needed to spin the gear against the pawl), but do not have a strong haptic and/or tactile feedback. Similarly, conventional reversible linear ratchet mechanisms have a strong haptic and/or tactile feedback, but have a high reverse torque.

As discussed in detail below, Applicant has designed a reversible ratchet mechanism including a first spring extending between the pawls and a second spring positioned within the handle to press a ball detent into a switch. The first spring has a spring constant less than a spring constant of the second spring (i.e., first spring is weaker than second spring). Applicant believes the use of first and second springs in the reversible ratchet mechanism design discussed herein creates a reduced reverse torque while maintaining a strong tactile feedback for a linear switch. Additionally, Applicant believes the position of the linear switch and use of a strong second spring reduces the risk of accidental actuation of the ratchet mechanism.

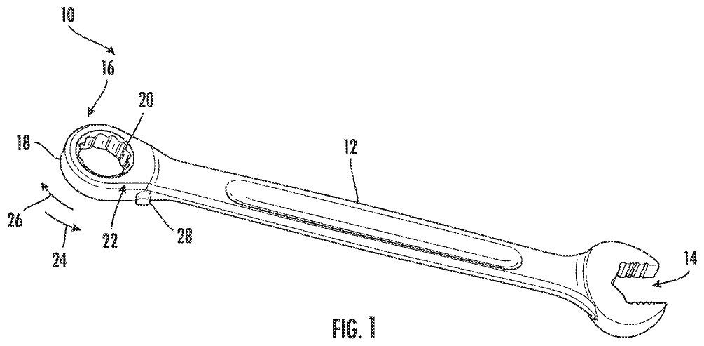

Referring to FIG. 1, a tool, such as wrench 10, is shown according to an exemplary embodiment. In the embodiment shown, wrench 10 is a combination wrench including a tool body 12, an open wrench end 14 and a ratchet head or end 16. Ratchet head 16 is formed from a generally ring-shaped portion 18 of tool body 12 that surrounds and supports wrench engagement surfaces 20. As will be understood, in use, a workpiece engagement structure shown as wrench engagement surfaces 20 engage a component of a workpiece (e.g., a fastener, a bolt, a nut, etc.) and a tool body 12 acts as a handle and a lever to apply torque to the component. Wrench 10 includes a ratchet mechanism 22 that is supported within a tool body 12 and ratchet mechanism 22 provides ratcheting action to wrench engagement surfaces 20.

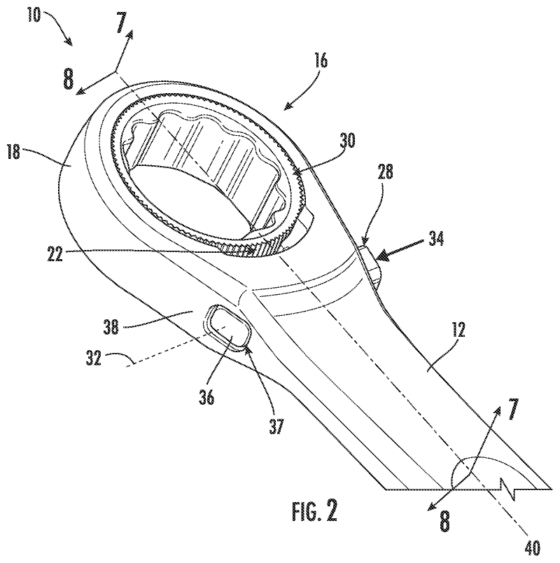

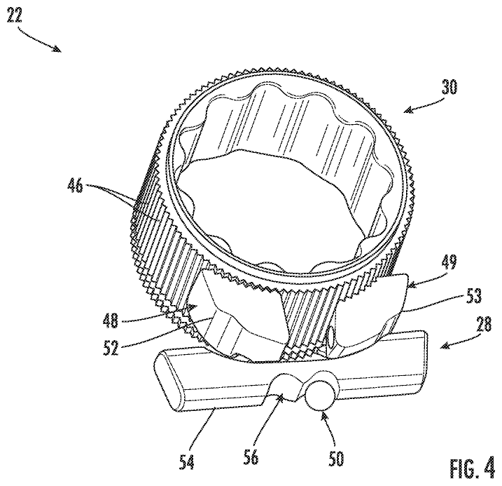

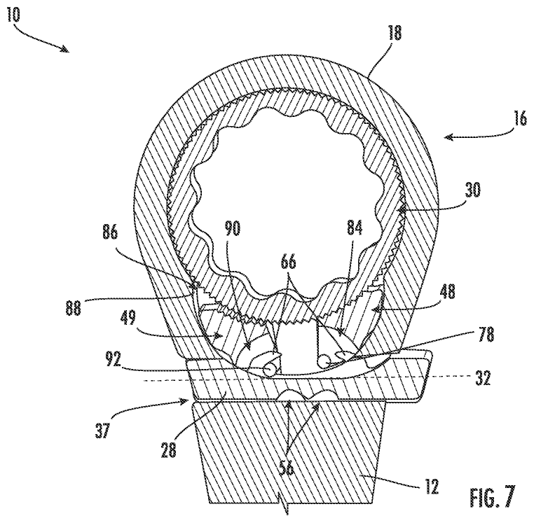

Wrench 10 includes a switching mechanism, shown as a switch, and specifically a linear switch 28 allowing a user to select a torque direction such that ratchet mechanism 22 is a reversible ratchet mechanism. In a specific embodiment, the switching mechanism is a linear switch formed from an elongated element positioned within a channel or passageway 37 (see e.g., FIGS. 2 and 7) formed in tool body 12 transverse to a longitudinal axis 40 of wrench 10 and tool body 12. In other words, linear switch 28 extends through tool body 12 in a transverse direction to longitudinal axis 40. Specifically, linear switch 28 is movable between a first position, in which driving happens in a first direction and a second position, in which driving happens in a second direction, opposite of the first direction. In other words, linear switch 28 is translationally moveable within channel 37 between a first driving position in which a first pawl 48 (see e.g., FIG. 4) is engaged with the gear 30 and a second pawl 49 (see e.g., FIG. 4) is disengaged from gear 30 by the linear switch and a second driving position in which second pawl 49 is engaged with gear 30 and first pawl 48 is disengaged from gear 30 by linear switch 28. Linear switch 28 is positioned between generally ring-shaped portion 18 and tool body 12 of wrench 10.

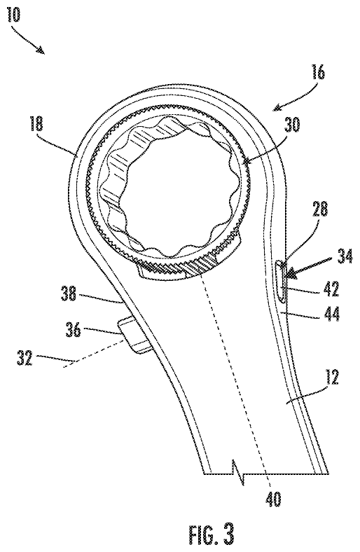

Referring to FIGS. 2-3 rear perspective views of wrench 10 with the linear switch 28 of the ratchet mechanism 22 in a first position (see e.g., FIG. 2) and a second position (see e.g., FIG. 3) are shown. When linear switch 28 is in the first position, the first pawl 48 (see e.g., FIG. 4) is engaged with the gear 30. Ratchet mechanism 22 prevents tool body 12 from freely rotating around engagement surfaces 20 and around a fastening component located within engagement surfaces 20) such that torque applied to tool body 12 is transferred to engagement surfaces 20 and to the fastening component located within engagement surfaces 20. Specifically, torque is applied in a first drive direction, shown by arrow 24 while free unrestricted rotation of tool body 12 around engagement surfaces 20 is allowed in a second direction, shown by arrow 26. A driving axis or rotational axis of wrench 10 is generally perpendicular (i.e., 90 degrees plus or minus 10 degrees) to tool body 12.

When linear switch 28 is in the second position, the second pawl 49 (see e.g., FIG. 4) is engaged with the gear 30, the first pawl 48 disengages from gear 30 and ratchet mechanism 22 prevents tool body 12 from freely rotating around engagement surfaces 20 and around a fastening component located within engagement surfaces 20) such that torque applied to tool body 12 is transferred to engagement surfaces 20 and to the fastening component located within engagement surfaces 20. Specifically, torque is applied in a second drive direction, shown by arrow 26 while free unrestricted rotation of tool body 12 around engagement surfaces 20 is allowed in a first direction, shown as arrow 24.

Tool body 12 defines the longitudinal or medial axis 40 of wrench 10. Linear switch 28 extends along a switch longitudinal axis 32. Switch longitudinal axis 32 is generally perpendicular (e.g., 90 degrees plus or minus 10 degrees) to the longitudinal axis 40 of wrench 10. When a user actuates linear switch 28, a force, shown by arrow 34 is applied to linear switch 28 moving and/or translating linear switch 28 along switch longitudinal axis 32 between the first drive position and the second drive position. In such embodiments, linear switch 28 moves in a nonpivoting manner.

As shown in FIG. 2, generally ring-shaped portion 18 includes a first outer side surface 38 located adjacent to an end surface 36 of linear switch 28. In the first drive position, end surface 36 is positioned on the end of linear switch 28 opposing the actuation end (i.e., where force 34 is applied) that includes an opposing end surface 42. When linear switch 28 is in the first drive position, end surface 36 is recessed (i.e., closer to longitudinal axis 40 of tool body 12) relative to first outer side surface 38 and end surface 42 projects and/or extends beyond (i.e., farther away from longitudinal axis 40 of tool body 12) first outer side surface 38 of generally ring-shaped portion 18.

As shown in FIG. 3, when linear switch 28 is actuated into the second drive position, end surface 36 projects and/or extends beyond (i.e., farther away from longitudinal axis 40 of tool body 12) a second outer side surface 44 of generally ring-shaped portion 18. The first outer side surface 38 and second outer side surface 44 generally define a thickness of the wrench 10 and extend between an upper and lower surface of wrench 10 in a direction parallel to the driving axis. The driving axis is perpendicular to longitudinal axis 40 and extends through head 16.

Referring to FIG. 4, components of ratchet mechanism 22 are shown in detail. In the orientation of FIGS. 1 and 4, ratchet mechanism 22 includes a sprocket or gear 30. Gear 30 is a generally ring or annularly shaped structure that is coupled to and/or includes an inner surface that defines an opening in which engagement surfaces 20 are located. The outer surface of gear 30 includes a plurality of teeth 46 which face radially outward from gear 30. Ratchet mechanism 22 further includes the first pawl 48 and the second pawl 49. First pawl 48 includes a first radially outward facing surface 52 and second pawl 49 includes a second radially outward facing surface 53.

Linear switch 28 includes a bottom or downward facing surface 54 (i.e., away from gear 30) that extends between end surface 36 and opposing end surface 42. Bottom surface 54 includes a recess or notch 56. In a specific embodiment, bottom surface 54 includes two notches 56, a first notch 56 and a second notch 56. A ball 50 is shown positioned within the notch 56.

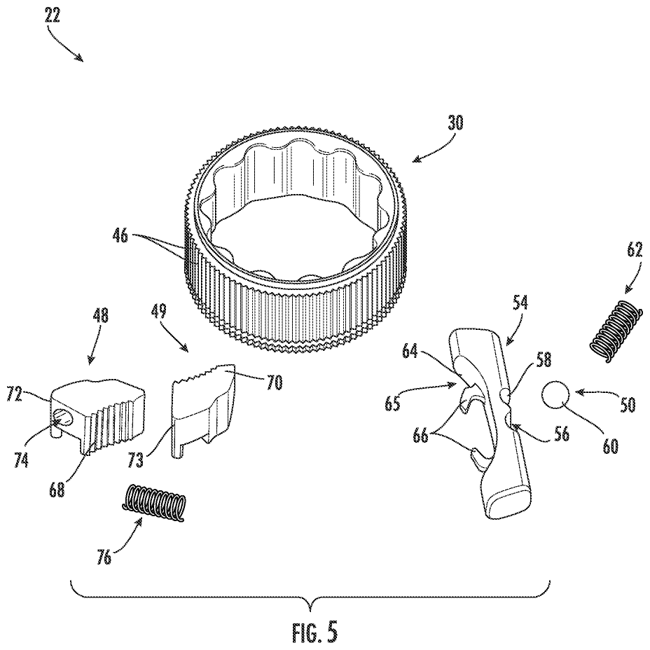

Referring to FIG. 5, an exploded view of the ratchet mechanism 22 is shown, according to an exemplary embodiment. Linear switch 28 and specifically notch 56, further includes an engagement surface 58. Engagement surface 58 engages and/or interfaces against an outer surface 60 of ball 50. A biasing component, shown as spring 62 presses ball 50 into bottom surface 54 to engage linear switch 28. Ball 50 is positioned between linear switch 28 and spring 62 and engages linear switch 28 and spring 62.

When linear switch 28 is in the first drive position, spring 62 presses ball 50 into a notch 56 (i.e., the first notch) maintaining the position of linear switch 28 in place and resisting any accidental actuation or translating movement of linear switch 28 (i.e., user bumping end of linear switch with hand and/or object). When linear switch 28 is moving into the second drive position (i.e., translating along longitudinal axis 32), spring 62 is compressed within the tool body 12. Once linear switch 28 is in the second drive position, spring 62 returns to an uncompressed state and presses ball 50 into the second notch 56 maintaining the position of linear switch 28 such that linear switch 28 resists translating motion.

In other words, when linear switch 28 is in the first driving position, spring 62 applies a locking force on ball 50 such that ball 50 engages the first notch 56 of linear switch 28 with ball 50 resisting movement of linear switch 28 such that switch 28 is secured relative to body 12 of wrench 10. When linear switch 28 is in the second driving position, spring 62 applies a locking force on ball 50 such that ball 50 engages the second notch 56 of linear switch 28 with ball 50 resisting movement of linear switch 28 such that switch 28 is secured relative to body 12 of wrench 10. When a force greater than the locking force is applied to linear switch 28, spring 62 is compressed within body 12 such that linear switch 28 is translatable within channel 37. Spring 62 is positioned such that spring 62 applies at least a portion of the force parallel to the longitudinal axis 40 and at least a portion of the force perpendicular to the rotational axis.

Linear switch 28 further includes a top or upward facing surface 64 (i.e., facing gear 30) that extends between end surface 36 and opposing end surface 42 and opposes bottom surface 54. Upward facing surface includes a scooped or recessed portion 65 (i.e., smaller distance to longitudinal axis 32. A pair of arms or hooks 66 project from upward facing surface 64 and specifically scooped portion 65 toward gear 30 and pawls 48, 49 when wrench 10 is assembled. Hooks 66 are configured to engage with pawls 48, 49 and selectably move first pawl 48 and second pawl 49 into and out of engagement with gear 30 depending on the drive position. In other words, the pair of arms 66 extend toward gear 30 and are configured to engage with first pawl 48 and second pawl 49 to selectably move first pawl 48 and second pawl 48 into and out of engage gear 30.

First pawl 48 includes a plurality of pawl teeth 68 and second pawl 49 includes a plurality of pawl teeth 70. A biasing surface 72 of first pawl 48 is positioned between and joined to first radially outward facing surface 52 and the opposing surface containing pawl teeth 68. Biasing surface 72 includes a bore 74 configured to receive a biasing component. Second pawl 49 similarly includes a biasing surface 73. When ratchet mechanism 22 is assembled, biasing surface 72 of first pawl 48 faces biasing surface 73 of second pawl 49 (see e.g., FIGS. 4 and 7). A pawl biasing component, shown as a spring 76 is coupled to and extends between first pawl 48 and second pawl 49 and specifically biasing surfaces 72 and 73. Spring 76 presses first pawl 48 and second pawl 49 apart maintaining a space between the pawls 48, 49. In other words, spring 76 biases first pawl 48 and second pawl 49 away from each other. A force applied by spring 76 is at least partially perpendicular to longitudinal axis 40 and the rotational axis.

In various specific embodiments, the pawl biasing component or spring 76 has a first spring constant and the switch biasing component or second spring 62 has a second spring constant. Pawl biasing spring 76 is weak relative to spring 62. In a specific embodiment, pawl biasing spring 76 has spring constant, K1 that is different from spring constant, K2 of spring 62. In a specific embodiment, pawl biasing spring 76 has a spring constant, K1 less than a spring constant, K2 of spring 62.

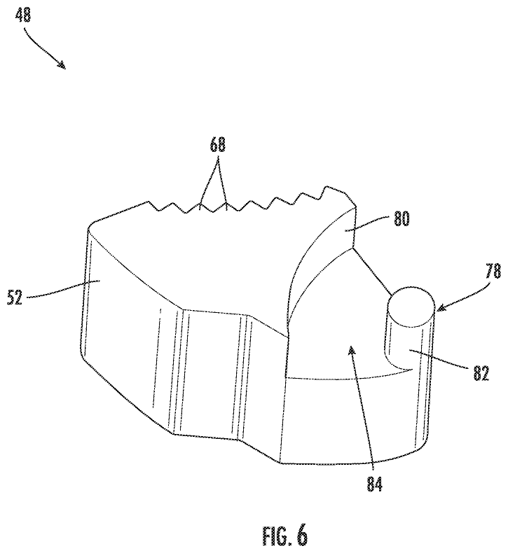

Referring to FIG. 6, a detailed perspective view of first pawl 48 is shown. Second pawl 49 includes the same features as first pawl 48 mirrored over the longitudinal axis 40 of wrench 10. First pawl 48 includes a post 78 with an outer surface 82. Post 78 extends toward hook 66 of linear switch 28 when ratchet mechanism 22 is assembled. First pawl 48 further includes an inward facing surface 80 (i.e., faces post 78 and longitudinal axis 40). In a specific embodiment, inward facing surface 80 is a curved surface. A channel 84 is defined between inward facing surface 80 and outer surface 82 of post 78.

Referring to FIG. 7, a cross-sectional view of wrench 10 taken along section line 7-7 of FIG. 2 is shown. Ratchet head 16, further includes a bore 86 to support ratchet mechanism 22 with an inner surface 88 defining bore 86. When ratcheting mechanism 22 is assembled and in a first drive position, a hook 66 is positioned in channel 84 and spaced from post 78 as first pawl 48 is engaged with gear 30. The remaining hook 66 is positioned within a channel 90 of second pawl 49 and engaged with a post 92 to pull, move and/or hold second pawl 49 in a position spaced from (i.e., disengaged) gear 30. When the linear switch 28 disengages the first pawl 48 and the second pawl 49 from the gear 30, the first pawl 48 and the second pawl 49 move in a nonpivoting, non-rotational or translational manner as the hook 66 engages with post 78 and post 92 of the first pawl 48 and second pawl 49 respectively.

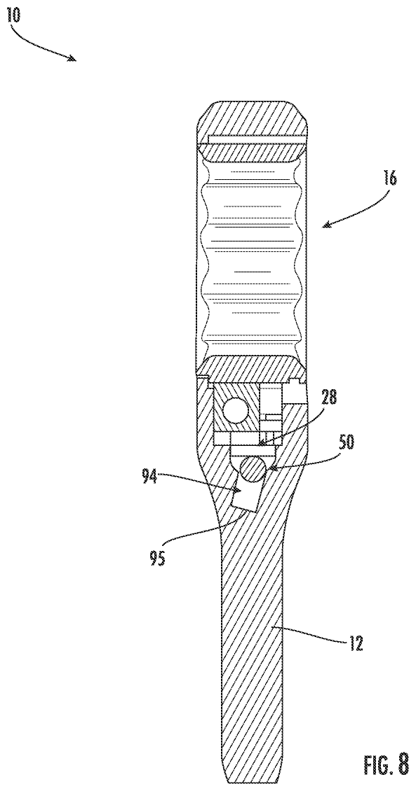

Referring to FIG. 8, a cross-sectional view of wrench 10 taken along section line 8-8 of FIG. 2 is shown with the spring 62 removed. Tool body 12 includes a recess 94. Recess 94 is sized to hold spring 62 that engages ball 50. When assembled, spring 62 extends between a bottom surface 95 of recess 94 and outer surface 60 of ball 50.

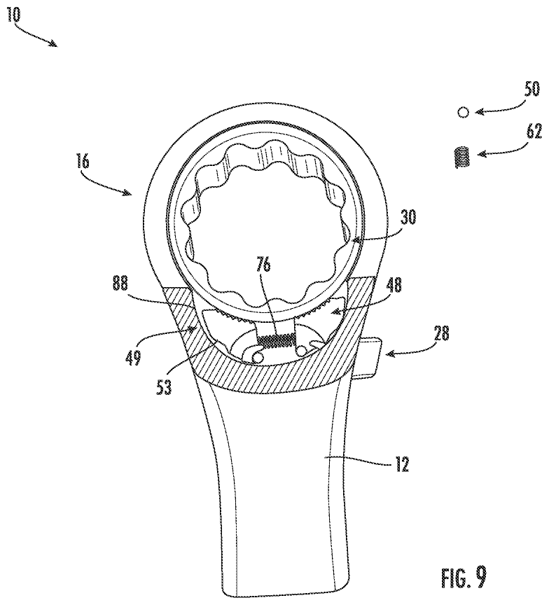

Referring to FIG. 9, a partially exploded rear perspective view of wrench 10 in the first driving position with a portion of the tool body 12 removed is shown. In a specific embodiment, the first spring 76 has a first length, L1 and the second spring 62 has a second length, L2. In a specific embodiment, the first length is different than the second length. In a specific embodiment, spring 76 has a length L1 that is greater than a length, L2 of spring 62.

As previously discussed, when ratchet mechanism 22 is in a first drive position, second pawl 49 is disengaged (i.e., spaced) from gear 30 by a hook 66 of linear switch 28 and pawl biasing spring 76 which pushes second pawl 49 and specifically second radially outward facing surface 53 toward inner surface 88 of bore 86. In such a position, ball 50 will be pressed into the medial notch 56 (i.e., positioned closer to longitudinal axis 40).

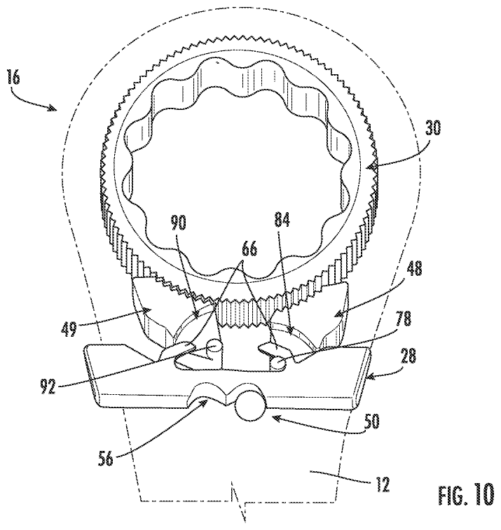

Referring to FIG. 10, a rear perspective view of wrench 10 in the second driving position is shown. A hook 66 is positioned in channel 84 and engaged with post 78 of first pawl to pull and/or hold first pawl 48 in a position spaced from (i.e., disengaged) gear 30. The remaining hook 66 is positioned in channel 90 and spaced from post 92 as second pawl 49 is engaged with gear 30. In such a position, ball 50 will be pressed into the lateral notch 56 (i.e., positioned larger distance from longitudinal axis 40).

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed:

1. A ratcheting wrench comprising:
a body extending along a longitudinal axis;
a head coupled to the body;
a workpiece engagement structure coupled to the head;
a ratchet mechanism supported by the head, the ratchet mechanism comprising:
a gear coupled to the workpiece engagement structure, the gear including a plurality of gear teeth;
a first pawl including a plurality of pawl teeth configured to engage the gear teeth of the gear;
a second pawl including a plurality of pawl teeth configured to engage the gear teeth of the gear; and
a first biasing component extending between and engaging the first pawl and the second pawl; and
a switching assembly positioned within the body, the switching assembly comprising:
an elongate switch;
a second biasing component; and
a ball positioned between the elongate switch and the second biasing component and engaging the elongate switch and the second biasing component;
wherein the elongate switch is translationally movable between a first driving position in which the first pawl is engaged with the gear and the second pawl is disengaged from the gear by the elongate switch and a second driving position in which the second pawl is engaged with the gear and the first pawl is disengaged from the gear by the elongate switch.

2. The ratcheting wrench of claim 1, wherein the first biasing component has a first spring constant, and the second biasing component has a second spring constant.

3. The ratcheting wrench of claim 2, wherein the first spring constant is different from the second spring constant.

4. The ratcheting wrench of claim 2, wherein the first spring constant is less than the second spring constant.

5. The ratcheting wrench of claim 1, wherein the first biasing component has a first length and the second biasing component has a second length, and wherein the second length is different than the first length.

6. The ratcheting wrench of claim 5, wherein the first length is greater than the second length.

7. The ratcheting wrench of claim 1, wherein, when the elongate switch disengages the first pawl and the second pawl from the gear, the first pawl and the second pawl move in a nonpivoting manner.

8. The ratcheting wrench of claim 1, wherein the elongate switch is a linear switch extending through the body in a transverse direction to the longitudinal axis.

9. A ratcheting tool comprising:
a body extending along a longitudinal axis;
a head coupled to the body;
a workpiece engagement structure coupled to the head;
a ratchet mechanism supported by the head and coupled to the workpiece engagement structure, the ratchet mechanism comprising:
a gear including a plurality of gear teeth;
a first pawl comprising:
a plurality of pawl teeth configured to engage the gear teeth of the gear;
a first post having an outer surface;
a first inward facing surface facing the first post; and
a first channel defined between the first inward facing surface and the first post;
a second pawl comprising:
a plurality of pawl teeth configured to engage the gear teeth of the gear;
a second post having an outer surface;
a second inward facing surface facing the second post; and
a second channel defined between the second inward facing surface and the second post;
a pawl biasing component extending between and engaging the first pawl and the second pawl; and
a switching assembly positioned within the body, the switching assembly comprising:
a switch comprising:
a pair of arms extending toward the gear, the pair of arms configured to engage with the first pawl and the second pawl to selectably move the first pawl and the second pawl into and out of engagement with the gear;
a switch biasing component; and
a ball positioned between the switch and the switch biasing component and engaging the switch and the switch biasing component;
wherein the switching assembly is configured to move the ratchet mechanism between a first drive position and a second drive position.

10. The ratcheting tool of claim 9, wherein, when, the ratchet mechanism is in the first drive position, one of the pair of arms is positioned in the first channel and spaced from the first post as the first pawl is engaged with the gear.

11. The ratcheting tool of claim 9, wherein, when, the ratchet mechanism is in the first drive position, one of the pair of arms is positioned in the second channel and engaged with the second post to move the second pawl into a position disengaged from the gear.

12. The ratcheting tool of claim 9, the switch further comprising a bottom surface including a first recess and a second recess.

13. The ratcheting tool of claim 12, wherein, when the switch is in the first drive position, the switch biasing component presses the ball into the first recess of the switch such that the switch resists translating motion.

14. The ratcheting tool of claim 12, wherein, when the switch is in the second drive position, the switch biasing component presses the ball into the second recess of the switch such that the switch resists translating motion.

15. The ratcheting tool of claim 9, wherein the pawl biasing component has a first spring constant, and the switch biasing component has a second spring constant, and wherein the first spring constant is different from the second spring constant.

16. A reversible driving tool comprising:
a body extending along a longitudinal axis;
a head coupled to the body;
a workpiece engagement structure coupled to the head;
a ratchet mechanism supported by the head and coupled to the workpiece engagement structure, the ratchet mechanism comprising:
a gear including a plurality of gear teeth;
a first pawl a plurality of pawl teeth configured to engage the gear teeth of the gear;
a second pawl including a plurality of pawl teeth configured to engage the gear teeth of the gear; and
a first biasing component extending between and engaging the first pawl and the second pawl; and
a switching assembly positioned within the body, the switching assembly comprising:
a switch configured to engage with the first pawl and the second pawl to selectably move the first pawl and the second pawl into and out of engagement with the gear, the switch including a downward facing surface including a first recess and a second recess;
a second biasing component; and
a ball positioned between the switch and the second biasing component such that the ball engages the downward facing surface of switch and the second biasing component;
wherein the switch is translationally movable within a passageway extending through the body in a direction transverse to the longitudinal axis, and wherein the switch is moveable between a first driving position in which the first pawl is engaged with the gear and a second driving position in which the second pawl is engaged with the gear.

17. The reversible driving tool of claim 16, wherein, when the switch is in the first driving position, the second biasing component applies a locking force on the ball such that the ball engages the first recess of the switch, the ball resists movement of the switch such that the switch is secured relative to the body of the reversible driving tool.

18. The reversible driving tool of claim 16, wherein, when the switch is in the second driving position, the second biasing component applies a locking force on the ball such that the ball engages the second recess of the switch, the ball resists movement of the switch such that the switch is secured relative to the body of the reversible driving tool.

19. The reversible driving tool of claim 17, wherein, when a force greater than the locking force is applied to the switch, the second biasing component is compressed within the body such that the switch is translatable within the passageway.

20. The reversible driving tool of claim 16, wherein the first biasing component has a first spring constant, and the second biasing component has a second spring constant, and wherein the first spring constant is less than the second spring constant.
